(19) United States
(12) Patent Application Publication
(10) Pub. No.: US 2025/0351196 A1
(43) Pub. Date: Nov. 13, 2025

(54) METHOD AND APPARATUS FOR PERFORMING CONTENTION-BASED RANDOM ACCESS IN WIRELESS COMMUNICATION SYSTEM

(71) Applicant: SAMSUNG ELECTRONICS CO., LTD., Suwon-si (KR)

(72) Inventors: Weiping SUN, Suwon-si (KR); Sangyeob JUNG, Suwon-si (KR); Hyunjeong KANG, Suwon-si (KR)

(21) Appl. No.: 19/188,816

(22) Filed: Apr. 24, 2025

(30) Foreign Application Priority Data
May 9, 2024 (KR) 10-2024-0061372

(51) Int. Cl. H04W 74/0838; H04L 67/12; H04W 68/00

(52) U.S. Cl. CPC H04W 74/0838; H04L 67/12; H04W 68/005

(57) ABSTRACT

The disclosure relates to a 5G or 6G communication system for supporting a higher data transmission rate. According to various embodiments of the disclosure, a method for processing a control signal in a wireless communication system may include: receiving a first control signal transmitted from a base station; processing the received first control signal; and transmitting a second control signal generated based on the processing to the base station.

### CROSS-REFERENCE TO RELATED APPLICATION

This application is based on and claims priority under 35 U.S.C. § 119 to Korean Patent Application No. 10-2024-0061372, filed on May 9, 2024, in the Korean Intellectual Property Office, the disclosure of which is herein incorporated by reference in its entirety.

### BACKGROUND

### 1. Field

The disclosure generally relates to a wireless communication system and, more particularly, to a method and an apparatus for performing contention-based random access for an ambient Internet of Things (IoT) device in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

The above information is presented as background information only to assist with an understanding of the disclosure. No determination has been made, and no assertion is made, as to whether any of the above might be applicable as prior art with regard to the disclosure.

### SUMMARY

Based on the foregoing discussion, an aspect of the disclosure is to provide a method and an apparatus for defining a random access procedure for an ambient IoT device in a wireless communication system and performing the random access procedure.

The technical subjects pursued in the disclosure may not be limited to the above-mentioned technical subjects, and other technical subjects which are not mentioned herein may be clearly understood from the following description by those skilled in the art to which the disclosure pertains.

According to various embodiments of the disclosure, a method for processing a control signal in a wireless communication system may include: receiving a first control signal transmitted from a base station; processing the received first control signal; and transmitting a second control signal generated based on the processing to the base station.

An embodiment of the disclosure provides a device and a method capable of effectively providing services in a wireless communication system.

Advantageous effects obtainable from the disclosure may not be limited to the above-mentioned effects, and other effects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example structure of a wireless communication system according to an embodiment of the disclosure;

FIG. 2 illustrates an example radio protocol structure in a wireless communication system according to an embodiment of the disclosure;

FIG. 3 illustrates an example signal flow for a random access procedure according to an embodiment of the disclosure;

FIG. 4 illustrates an example topology and deployment scenario supporting ambient Internet of Things (A-IoT) communication in a wireless communication system according to an embodiment of the disclosure;

FIG. 5 illustrates an example process in which an A-IoT reader obtains information about an A-IoT device according to an embodiment of the disclosure;

FIG. 6 illustrates an example structure of a UE according to various embodiments of the disclosure; and

FIG. 7 illustrates an example structure of a base station according to various embodiments of the disclosure.

### DETAILED DESCRIPTION

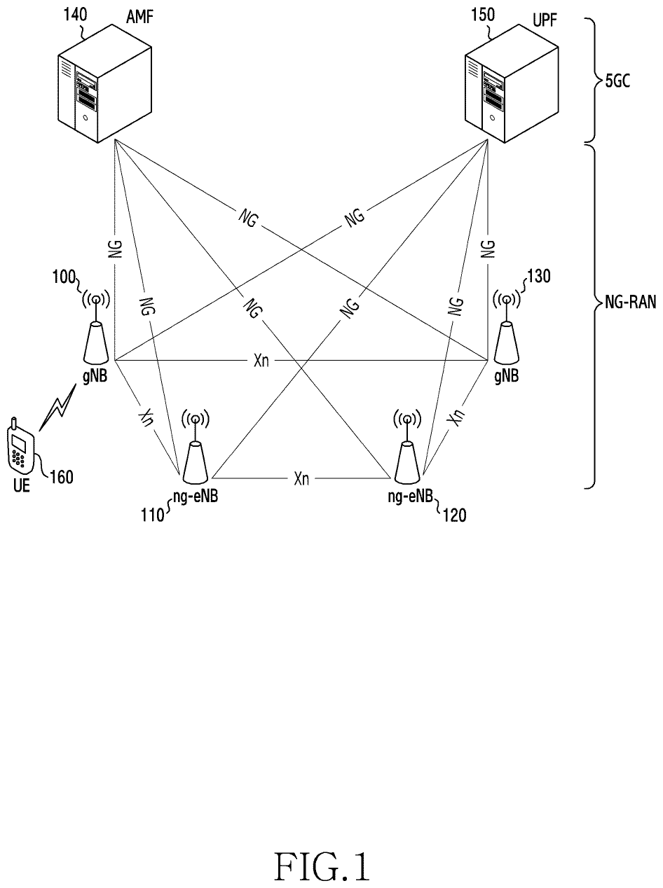

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. In addition, based on determinations by those skilled in the art, the embodiments of the disclosure may be applied to other communication systems through some modifications without significantly departing from the scope of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may be applied to other communication systems through some modifications without significantly departing from the scope of the disclosure.

In the following description, terms for identifying access nodes, terms referring to network entities or network functions (NFs), terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards.

FIG. 1 illustrates an example structure of a wireless communication system according to an embodiment of the disclosure. More specifically, FIG. 1 illustrates the structure of an NR system.

Referring to FIG. 1, the wireless communication system may include a plurality of base stations (e.g., a gNB 100, a ng-eNB 110, a ng-eNB 120, and a gNB 130), an access and mobility management function (AMF) 140, and a user plane function (UPF) 150. The wireless communication system is not limited to the components illustrated in FIG. 1, and may include more or fewer components.

According to an embodiment of the disclosure, a user equipment (hereinafter, a UE or terminal) 160 may access an external network through the base stations 100, 110, 120, and 130 and a UPF 150.

In FIG. 1, the base stations 100, 110, 120, and 130 are access nodes of a cellular network, and may provide wireless access for UEs accessing the network. For example, in order to serve user traffic, the base stations 100, 110, 120, and 130 may collect state information, such as the buffer status, available transmission power state, and channel state of the UEs, to perform scheduling and support connections between the UEs and a core network (CN) (particularly, a CN of NR is referred to as a 5GC).

In FIG. 1, the gNBs 100 and 130 may control a plurality of cells, and may apply an adaptive modulation and coding (AMC) scheme of determining a modulation scheme and a channel coding rate according to the channel state of the UE.

The core network is a device that is responsible for not only a mobility management function for the UE but also various control functions, and may be connected to the plurality of base stations. In addition, the 5GC may be linked with an existing LTE system.

In the wireless communication system, a user plane (UP) related to actual transmission of user data and a control plane (CP) for connection management may be separately configured. The gNB 100 and the gNB 130 of FIG. 1 may use UP and CP technologies defined in NR technology, and the ng-eNB 110 and ng-eNB 120 may use UP and CP technologies defined in Long Term Evolution (LTE) technology even though connected to the 5GC.

The AMF 140 is a device that is responsible for not only a mobility management function for the UE but also various control functions, and may be connected to the plurality of base stations.

The UPF 150 may refer to a type of gateway device that provides data transmission. Although not shown in FIG. 1, the NR wireless communication system may include a session management function (SMF). The SMF may manage packet data network connections, such as a protocol data unit (PDU) session provided to the UE.

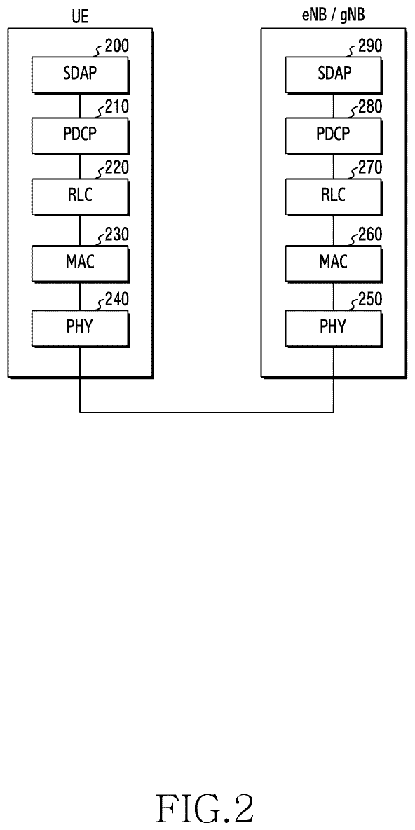

FIG. 2 illustrates an example wireless protocol structure in a wireless communication system according to an embodiment of the disclosure. More specifically, FIG. 2 illustrates a wireless protocol structure in an NR system.

Referring to FIG. 2, a wireless protocol of the NR system may include service data adaptation protocols (SDAPs) 200 and 290, packet data convergence protocols (PDCPs) 210 and 280, radio link controls (RLCs) 220 and 270, medium access controls (MACs) 230 and 260, and physicals (PHYs) 240 and 250 respectively at a UE and a base station.

The SDAP layers 200 and 290 may perform transfer of user data, an operation of mapping a quality-of-service (QOS) flow to a specific data radio bearer (DRB) for an uplink and a downlink, an operation of marking a QoS flow ID for an uplink and a downlink, and an operation of mapping a reflective QoS flow to a data bearer for uplink SDAP PDUs. An SDAP configuration corresponding to each DRB may be provided from a higher RRC layer. However, the SDAP layers 200 and 290 are not limited to the illustration operations.

The PDCP layers 210 and 280 may be responsible for an operation of compressing/decompressing an IP header. Further, the PDCPs 210 and 280 may provide in-sequence and out-of-sequence delivery functions, perform reordering, and provide a duplicate detection function, a retransmission function, and ciphering and deciphering functions. However, the PDCP layers 210 and 280 are not limited to the illustrated functions.

The RLC layers 220 and 270 may reconfigure a PDCP PDU in an appropriate size. Further, the RLC layers 220 and 270 may provide in-sequence and out-of-sequence delivery functions, an automatic repeat request (ARQ) function, concatenation, segmentation, and reassembly functions, a re-segmentation function, a reordering function, a duplicate detection function, and an error detection function. However, the RLC layers 220 and 270 are not limited to the illustrated functions.

The MAC layers 230 and 260 may be connected to a plurality of RLC layer devices configured in one UE, and may perform an operation of multiplexing RLC PDUs into a MAC PDU and demultiplexing RLC PDUs from a MAC PDU. Further, the MAC layers 230 and 260 may provide a mapping function, a scheduling information reporting function, a hybrid ARQ (HARQ) function, a priority handling function between logical channels, a priority handling function between UEs, a multimedia broadcast multicast service (MBMS) service identification function, a transport format selection function, and a padding function. However, the MAC layers 230 and 260 are not limited to the illustrated functions.

The PHY layers 240 and 250 perform channel coding and modulation of higher-layer data and convert the data into orthogonal frequency division multiplexing (OFDM) symbols to transmit the OFDM symbols via a wireless channel, or demodulate OFDM symbols received via a wireless channel and perform channel decoding of the OFDM symbols to deliver the OFDM symbols to a higher layer. The PHY layers also use an HARQ for additional error correction, and a receiver transmits whether a packet transmitted by a transmitter has been received by using one bit. One-bit information is referred to as HARQ acknowledgement (ACK)/negative ACK (NACK) information.

In LTE, downlink HARQ ACK/NACK information for uplink data transmission may be transmitted through a physical hybrid-ARQ indicator channel (PHICH). In NR, whether retransmission is needed or whether new transmission is required may be determined through scheduling information about the UE through a physical downlink control channel (PDCCH), which is a channel through which uplink/downlink resource allocation is transmitted, because an asynchronous HARQ is applied in NR. Uplink HARQ ACK/NACK information for downlink data transmission may be transmitted through a physical uplink control channel (PUCCH) or a physical uplink shared channel (PUSCH). The PUCCH is generally transmitted in an uplink in a PCell to be described below. However, when the UE supports the PUCCH, the base station may additionally transmit the PUCCH to the UE in a SCell to be described below, which may be referred to as a PUCCH SCell.

Although not shown in FIG. 2, radio resource control (RRC) layers exist above the PDCP layers of the UE and the base station. The RRC layers may transmit and receive access and measurement-related configuration control messages for radio resource control.

The PHY layers may include one frequency/carrier or a plurality of frequencies/carriers, and a technology for simultaneously configuring and using a plurality of frequencies may be referred to as carrier aggregation (CA). The CA technology may dramatically increase transmission volume by the number of subcarriers by additionally using a primary carrier and one subcarrier or a plurality of subcarriers for communication between a UE and a base station (e.g., an eNB or gNB), in which one carrier is generally used. In LTE/NR, a cell in a base station using a main carrier is referred to as a main cell or a primary cell (PCell), and a cell in a base station using a subcarrier is referred to as a sub-cell or a secondary cell (SCell).

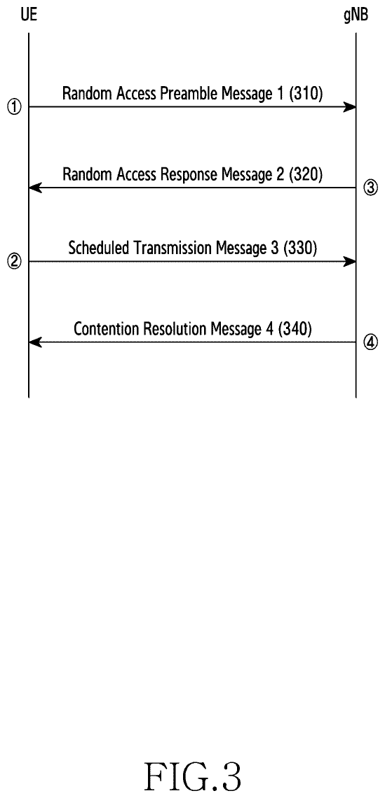

FIG. 3 illustrates an example signal flow for a random access procedure according to an embodiment of the disclosure.

FIG. 3 illustrates a contention-based random access procedure according to an embodiment. Although not illustrated in FIG. 3, a base station may transmit a synchronization signal block. In this case, the base station may periodically transmit the synchronization signal block by using beam sweeping. For example, the base station may transmit a synchronization signal block (e.g., an SS/PBCH (SSB) block) including a primary synchronization signal (PSS)/secondary synchronization signal (SSS) (synchronization signal) and a physical broadcast channel (PBCH) (broadcast channel) signal by using up to 64 different beams for 5 ms, and a plurality of synchronization signal blocks may be transmitted using different beams.

In a first operation 310, a UE may detect (select) a synchronization signal block having an optimal beam direction (e.g., the direction of a beam having the highest received signal strength or a received signal strength greater than a predetermined threshold value), and may transmit a preamble by using a physical random access channel (PRACH) resource related to the detected synchronization signal block. For example, in the first operation 310 of the random access procedure, the UE may transmit a random access preamble (or message 1) to the base station. The base station receiving the random access preamble may measure a transmission delay value between the UE and the base station, and may perform uplink synchronization. Specifically, the UE may transmit a random access preamble randomly selected from a random access preamble set given by system information in advance. The initial transmission power of the random access preamble may be determined according to path loss between the base station and the UE measured by the UE. Further, the UE may determine the transmission beam direction (or transmission beam or beam) of the random access preamble, based on a synchronization signal block received from the base station, and may transmit the random access preamble by applying the determined transmission beam direction.

In a second operation 320, the base station may transmit a response (random access response: RAR) (or message 2 (msg2)) to the UE in response to a detected random access attempt. The base station may transmit an uplink transmission timing control command to the UE from the transmission delay value measured based on the random access preamble received in the first operation 310. In addition, the base station may transmit an uplink resource to be used by the UE and a power control command as scheduling information. The scheduling information transmitted by the base station may include control information about an uplink transmission beam of the UE. The RAR may be transmitted through a PDSCH, and may include at least one of the following information.

Sequence index of random access preamble detected by network (or base station)

Temporary cell radio network temporary identifier (TC-RNTI)

Uplink scheduling grant

Timing advance value

According to an embodiment, when the UE fails to receive the RAR, which is scheduling information for message 3, from the base station for a predetermined time in the second operation 320, the first operation 310 may be performed again. When the first operation 310 is performed again, the UE may transmit the random access preamble with transmission power increased by a certain step (e.g., power ramping), thereby increasing a probability that the base station receives the random access preamble.

In the third operation 330, the UE may transmit uplink information (e.g., scheduled transmission or message 3) including a UE ID (e.g., a UE contention resolution identity) of the UE (or a valid UE ID (C-RNTI) when the UE already has the UE identifier valid in a cell before starting the random access procedure) to the base station through an uplink data channel (physical uplink shared channel (PUSCH)) by using the uplink resource allocated in the second operation 320. The PUSCH may be referred to as a message-3 PUSCH (msg3 PUSCH). The transmission timing of the uplink data channel for transmitting message 3 may be controlled according to the uplink transmission timing control command received from the base station in the second operation 320. Transmission power for the uplink data channel for transmitting message 3 may be determined by considering the power control command received from the base station in the second operation 320 and a power ramping value of the random access preamble. The uplink data channel for transmitting message 3 may include an initial uplink data signal transmitted by the UE to the base station after the UE transmits the random access preamble.

In the fourth operation 340, when determining that the UE has performed random access procedure without colliding with another UE, the base station may transmit a message (e.g., a contention resolution (CR) message) including the ID of the UE transmitting the uplink data in the third operation 330 or message 4 to the UE. Here, when a plurality of UEs receives the same TC-RNTI in the second operation 320, the plurality of UEs receiving the same TC-RNTI may each transmit message 3 including a UE ID (UE contention resolution identity) thereof to the base station in the third operation 330. The base station may transmit message 4 (CR message) including one UE ID among the plurality of UE IDs to resolve contention. When receiving message 4 (CR message) including the UE ID of the UE from the base station in the fourth operation 450 in the fourth operation 340 (or when transmitting message 3 including the UE ID (C-RNTI) in the third operation 330 and receiving UE-specific control information including a cyclic redundancy check (CRC) based on the UE ID (C-RNTI) through a PDCCH in the fourth operation 340), the UE may determine that the random access is successful. Accordingly, the UE identifying that the UE ID thereof is included in message 4 (CR message) among the plurality of UEs receiving the same TC-RNTI from the base station may identify that the contention is successful. The UE may transmit an HARQ-ACK/NACK indicating whether message 4 is successfully received to the base station through an uplink control channel (physical uplink control channel (PUCCH)).

According to an embodiment, when the base station fails to receive a data signal from the UE due to a collision between data transmitted by the UE in the third operation 330 and data of another UE, the base station may no longer transmit data to the UE. When the UE fails to receive data transmitted from the base station in the fourth operation 340 for a certain time period, the UE may determine that the random access procedure has failed, and may restart the random access procedure from the first operation 310.

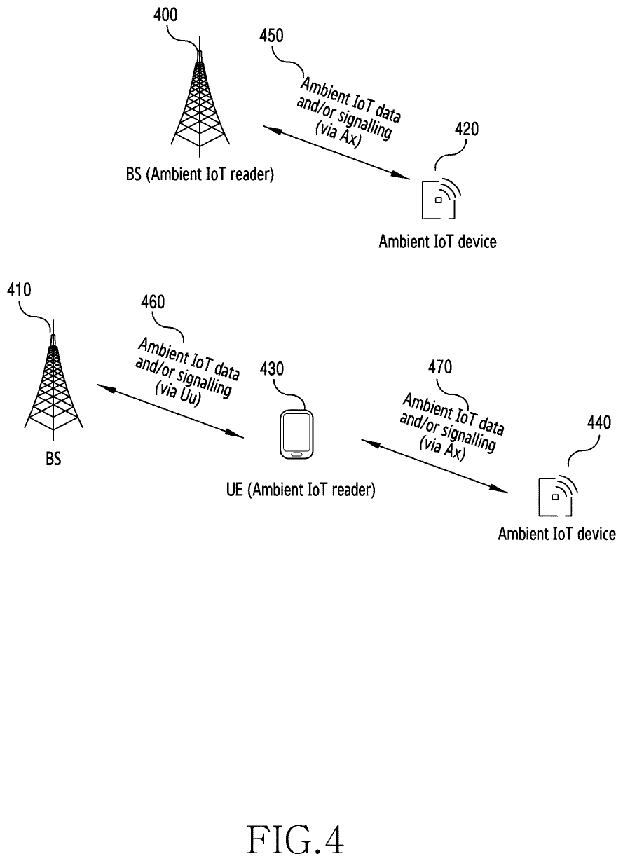

FIG. 4 illustrates an example topology and deployment scenario supporting ambient Internet of Things (A-IoT) communication in a wireless communication system according to an embodiment of the disclosure.

According to various embodiments of the disclosure, an A-IoT device 420 or 440 is a device with very low maximum power consumption, and may support a peak power consumption of up to 1 uW or a peak power consumption of hundreds of uW. The A-IoT device may basically perform uplink transmission (e.g., from the A-IoT device to an A-IoT reader) through backscattering. For example, the foregoing device may perform uplink transmission by using an external carrier wave. During the uplink transmission, the A-IoT device may or may not perform amplification. The A-IoT device may also internally generate and perform uplink transmissions. According to an embodiment, the A-IoT device do not have an RRC state, and do not support mobility, such as cell selection or cell reselection. In addition, the A-IoT device may include a low-end device that does not support an HARQ and an ARQ.

According to an embodiment, the A-IoT device 420 or 440 may refer to a device that is capable of utilizing power by energy harvesting and does not have a battery or has a limited energy storage capability.

According to an embodiment, the A-IoT device may perform bidirectional communication directly with an A-IoT reader.

According to an embodiment, the A-IoT reader may include a base station 400. In this case, the A-IoT device 420 may perform bidirectional communication directly with the base station 400. For example, the A-IoT device 420 may transmit and receive 450 A-IoT data and/or a signal to and from the base station 400. According to an embodiment, the A-IoT device 420 may be located indoors, and the base station 400 may also be located indoors. The foregoing communication is not supported through a conventional Uu interface between a UE and a base station, but may be supported through a new interface. In the disclosure, the new interface may be referred to as an Ax interface.

According to an embodiment, the A-IoT reader may be a UE 430. In this case, the A-IoT device 440 may perform bidirectional communication directly with the UE 430. For example, the A-IoT device 440 may transmit and receive (470) A-IoT data and/or signal to and from the UE 430. According to an embodiment, the A-IoT device 440 may be located indoors, and the UE 430 may also be located indoors. The foregoing communication is not supported through a conventional Uu interface between a UE and a base station, but may be supported through a new interface. In the disclosure, the new interface may be referred to as an Ax interface. In addition, the UE 430 may perform bidirectional communication 460 with a base station 410 through the Uu interface. For example, the A-IoT device 440 may transmit and receive (470) A-IoT data and/or signal to and from the UE 430 operating as the A-IoT reader, and the UE 430 may transmit and receive (460) A-IoT data and/or signal to and from the base station 410. For reference, the base station 410 may be located outdoors.

According to an embodiment, the A-IoT device may generally include a low-end IoT device, and may usually have a transmission/reception distance of 10 and 50 m to the A-IoT reader indoors. Generally, the A-IoT device may be attached to an object/item to record the location and state of the object/item and to transmit location and state information to a network through the A-IoT reader. For example, a system may be designed such that an A-IoT device may be attached to each of hundreds or thousands of items in a logistics warehouse, and when tracking the location and delivery status of each item is required, the presence or absence and location of the A-IoT device attached to the item may be transmitted to the network through the A-IoT reader to remotely track the device. Therefore, a plurality of A-IoT devices may exist within the transmission range of a specific A-IoT reader, and accordingly a method for the A-IoT reader to identify the presence or absence of the plurality of neighboring A-IoT devices and to obtain device information is required.

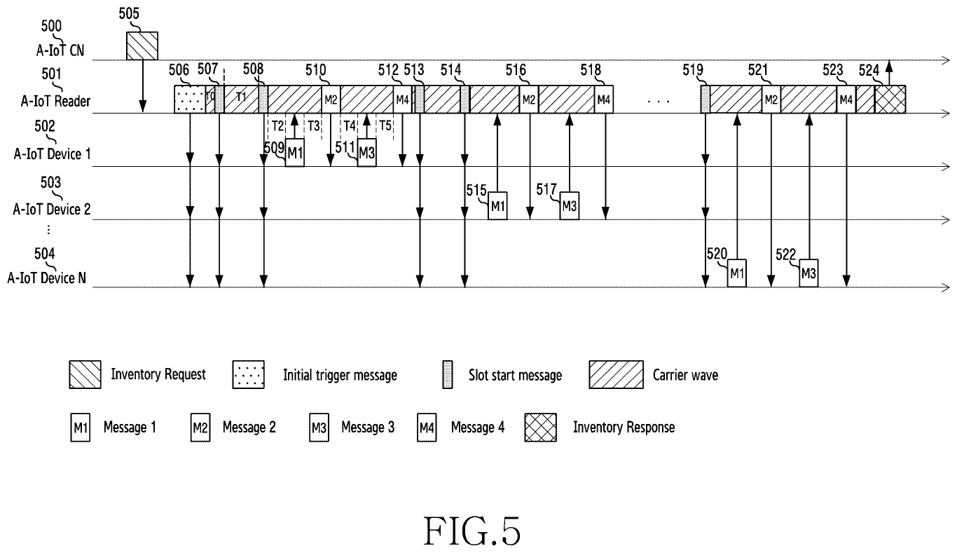

FIG. 5 illustrates an example process in which an A-IoT reader obtains information about a neighboring A-IoT device according to an embodiment of the disclosure. More specifically, FIG. 5 illustrates an inventory process in which an A-IoT reader identifies whether there is a neighboring A-IoT device and obtains information about the A-IoT device.

Referring to FIG. 5, a specific device 500 of a core network (CN) may communicate with an A-IoT reader 501. For example, the device may be referred to as an A-IoT CN device. The disclosure does not limit the designation of the device. The A-IoT CN device 500 may transmit an inventory request to the A-IoT reader 501. According to an embodiment, the request may be transmitted through a specific message. For example, the message including the inventory request may be referred to as an inventory request message 505 and the message including inventory response may be referred to as an inventory response 524. According to various embodiments of the disclosure, the message is not limited to the foregoing designation. According to an embodiment, the A-IoT CN device 500 may transmit and receive a signal to and from an A-IoT device (e.g., A-IoT Device 1 502, A-IoT Device 2 503 or A-IoT Device N 504) through the A-IoT reader (e.g., a UE or a base station).

According to an embodiment of the disclosure, the inventory request message 505 may include at least one of the following information.

The inventory request message 505 may include an identity (ID) corresponding to a target A-IoT device to be inventoried. According to an embodiment, the inventory request message 505 may include a specific A-IoT device ID or a plurality of A-IoT device IDs. According to an embodiment, the inventory request message 505 may include IDs of the plurality of A-IoT devices in the form of an ID list, or may include a group ID to which the plurality of A-IoT devices belongs. According to an embodiment, the A-IoT device ID or the group ID may be a temporarily assigned ID or group ID, or may be a permanent ID or group ID. According to an embodiment, the A-IoT device ID or group ID may include an ID or group ID of the A-IoT device, or may include an ID or group ID of an item/object to which the A-IoT device is attached.

The inventory request message 505 may include a characteristic of the target A-IoT device to be inventoried. For example, the characteristic of the target A-IoT device may refer to a functional characteristic of the A-IoT device or a characteristic of the item/object to which the A-IoT device is attached.

The inventory request message 505 may include a request/service/session ID/number by which the A-IoT reader may identify the inventory request/service/session. According to an embodiment, when a plurality of inventory/random access rounds needs to be requested with respect to the inventory request/service/session, the inventory request message 505 may include a periodicity for performing the inventory/random access rounds and/or the (maximum) number of inventory/random access rounds. According to an embodiment, when the inventory request message 505 includes the periodicity for performing the inventory/random access rounds, the A-IoT reader may perform/trigger each inventory/random access round according to the periodicity after receiving the inventory request message. According to an embodiment, when the inventory request message 505 includes the (maximum) number of inventory/random access rounds, the A-IoT reader may trigger (or perform) the inventory/random access rounds as many times as the number or less after receiving the inventory request message. According to an embodiment, after receiving the inventory request message, the A-IoT reader may perform one inventory/random access round or a plurality of inventory/random access rounds with respect to the inventory request/service/session by the internal configuration of the A-IoT reader. For example, when succeeding in inventory/random access in a specific inventory/random access round, the A-IoT device may not participate in a further inventory/random access round for the same inventory request/service/session. For example, the A-IoT reader may start/trigger an inventory/random access round by transmitting a specific message. According to an embodiment, the specific message may be referred to as an initial trigger message, but is not limited to this designation.

Referring to FIG. 5, the A-IoT reader that receives the inventory request 505 from the A-IoT CN device may transmit an initial trigger message 506. According to an embodiment, the initial trigger message 506 may be referred to as an A-IoT paging message. The disclosure does not limit the designation of the foregoing message.

According to an embodiment of the disclosure, the initial trigger message 506 may include at least one of the following information.

Target A-IoT device criteria: The initial trigger message 506 may include criteria/conditions of the target A-IoT device to participate in inventory and/or random access among the A-IoT devices having received the initial trigger message. According to an embodiment, the criteria/conditions of the target A-IoT device may include the ID of the A-IoT device or the item/object to which the A-IoT device is currently attached. The ID may refer to a temporary or permanent ID of the A-IoT device or the item/object to which the A-IoT device is currently attached. When there are one or more target A-IoT devices, criteria/conditions of the target A-IoT devices may include an ID list or a group ID to which the target A-IoT devices belong. According to an embodiment, the criteria/conditions of the target A-IoT device may include a feature/function that the target A-IoT device needs to have. According to an embodiment, a case in which the criteria/conditions of the target A-IoT device are not included in the initial trigger message may mean that all neighboring A-IoT devices are target A-IoT devices. According to an embodiment, when there is the criteria/conditions of the target A-IoT device, the A-IoT device having received the initial trigger message may determine whether the A-IoT device having received the initial trigger message satisfies the criteria. When the A-IoT devices having received the initial trigger message satisfy the criteria, the A-IoT devices may participate in the inventory/random access. When the A-IoT devices having received the initial trigger message do not satisfy the criteria, the A-IoT devices may not participate in the inventory/random access. According to an embodiment, when the initial trigger message does not include the criteria of the target A-IoT device, all A-IoT devices having received the initial trigger message may participate in the inventory/random access. According to an embodiment, when the initial trigger message includes a corresponding inventory request/service/session identifier (e.g., an inventory request/service/session ID/number), the A-IoT device may determine whether inventory/random access with respect to the inventory request/service/session is successful. The A-IoT device may participate in inventory/random access only when the inventory/random access with respect to the inventory request/service/session has not yet succeeded.

Random access occasion-related configuration information: The initial trigger message 506 may include at least one of the following information for configuring an occasion related to random access.

1) Time domain: The message may include the total number K of time slots/random access occasions in this inventory/random access round or the value of Q when the total number of time slots/random access occasions is expressed as 2^{Q} According to an embodiment, after receiving the total number K of time slots/random access occasions or the value of Q, the A-IoT device participating in the inventory/random access may randomly select one among all time slots/random access occasions (e.g., one among 0 to K-1, one among 1 to K, one among 0 to 2^{Q}−1, or one among 1 to 2^{Q}), and may transmit message 1 (Msg 1) 509, 515, and 520 in the corresponding time slot/random access occasion (e.g., time slot/random access occasion q). According to an embodiment, the length of one time slot/random access occasion may be configured. The length of a time slot/random access occasion may be configured to one or a combination of a plurality of units including symbol/slot/subframe/frame/us(microsecond)/ms(millisecond)/second. According to an embodiment, the length of a time slot may be defined in advance (or in specifications).

2) Frequency domain: The message may include line a coding/frequency shift parameter applicable when the A-IoT device transmits Msg 1 or other messages to the A-IoT reader. For example, the A-IoT device may transmit Msg 1 to the A-IoT reader by backscattering a carrier wave. Here, the line coding/frequency shift may be used to perform backscattering with a frequency higher or lower than the frequency of the carrier wave may be performed. A frequency shift (e.g., the difference between the frequency of the carrier wave and the frequency of a backscattered signal) that occurs at this time may be determined by the applied line coding/frequency shift parameter. For example, when different A-IoT devices apply different Miller/Manchester subcarrier frequencies (e.g., different numbers of subcarrier cycles per symbol), even when transmissions are performed in the same time slot/random access occasion, the transmissions may be performed using different frequencies, and thus the A-IoT reader may distinguishably receive corresponding signals. According to an embodiment, the line coding/frequency shift parameter is a parameter related to Miller, Manchester or other line coding/frequency shifts supportable by the A-IoT reader, and may be included in the form of a maximum value or a list of configurable values corresponding to the frequency shift that occurs. When the maximum value is included, all integer values that are less than or equal to the maximum value or that include 0 or do not include 0 may be considered applicable. According to an embodiment, when there is a supportable configuration among frequency shifts indicated with the line coding/frequency shift parameter by the A-IoT reader, the A-IoT device may randomly select the configuration or one of a plurality of configurations, and may apply the selected configuration when transmitting Msg 1 509, 515, and 520.

3) Code domain: The message may include configuration information about a code sequence that may be included when the A-IoT device transmits Msg 1. For example, the message may indicate at least one of a root sequence of the code sequence and/or the total number of code sequences supported by the A-IoT reader. When supporting generation of the code sequence, the A-IoT device may randomly generate one of all indicated sequences, based on the indicated root sequence, and transmit Msg 1 including the sequence. When different A-IoT devices select the same time slot/random access occasion and frequency shift but transmit different code sequences, the A-IoT reader may distinguish and receive the code sequences.

The initial trigger message 506 may configure at least one of the presence or absence of message 4 (Msg) or the length of Msg 4. According to an embodiment, Msg 4 may include all or part of message 3 (Msg 3). According to an embodiment, the length of Msg 4 indicating up to which bit Msg 4 includes starting from the first bit of Msg 3 may be configured.

The initial trigger message 506 may indicate the following time intervals between messages.

1) T0: The A-IoT reader may configure the minimum and/or maximum time interval between two consecutive messages transmitted to the A-IoT device. For example, referring to FIG. 5, the initial trigger message 506 may indicate the minimum and/or maximum time interval between the initial trigger message 506 and the next or previous message. For example, the initial trigger message 506 may configure the minimum and/or maximum time interval to a slot start message 507 (e.g., which may refer to a message indicating the start of a time slot/random access occasion on the time axis. For example, the message may include the index/number of the time slot/random access occasion.) to be transmitted next according to the initial trigger message 506. According to an embodiment, the minimum time interval may be configured in consideration of charging time for maintaining the A-IoT device in an always charged (power-up) state when receiving the two messages. For example, the maximum time interval may be determined by the configuration of the A-IoT reader. According to an embodiment, the minimum and/or maximum T) may be defined as a specific value in advance (or in the specifications).

2) T1: T1 may refer to time to wait until the next slot start message is transmitted when the A-IoT reader does not receive Msg 1 from the A-IoT device for T1 time after transmitting the slot start message 507. The initial trigger message 506 may indicate the minimum and/or maximum value of T1. According to an embodiment, the minimum and/or maximum value of T1 may be defined as a specific value in advance (or in the specifications).

3) T2: T2 may refer to a time/minimum time/maximum time interval from when the A-IoT device receives a slot start message 508 transmitted by the A-IoT reader or a message indicating the start of a time slot/random access occasion (on the time axis) (e.g., the initial trigger message may be used to indicate the start of a first time slot/random access occasion) to when the A-IoT device transmits Msg 1 509. According to an embodiment, the initial trigger message 506 may indicate the size and/or the maximum size and/or the minimum size of T2. According to an embodiment, the size and/or the minimum size and/or the maximum size of T2 may be defined as a specific value in advance (or in the specifications). According to an embodiment, when the A-IoT device receives the message indicating the start of the time slot/random access occasion and then selects the time slot/random access occasion indicated by the message for transmission of Msg 1, the A-IoT device may transmit Msg 1 within a time of T2.

4) T3: T3 may refer to a time/minimum time/maximum time interval in which the A-IoT device waits until a time of receiving message 2 (Msg 2) 510, 516, and 521 after transmitting Msg 1 509. According to an embodiment, the initial trigger message 506 may indicate the size and/or the minimum size and/or the maximum size of T3. According to an embodiment, the size and/or the minimum size and/or the maximum size of T3 may be defined as a specific value in advance (or in the specifications). According to an embodiment, when the A-IoT device does not receive Msg 2 in T3 or the minimum time of T3 or the maximum time of T3, the inventory/random access may be considered to have failed, the inventory/random access in the corresponding inventory/random access round for the corresponding inventory request/service/session may be considered to have failed, or the corresponding inventory request/service/session may be considered to have not yet succeeded. According to an embodiment, when the inventory/random access has failed, the inventory/random access in the corresponding inventory/random access round for the corresponding inventory request/service/session has failed, or the inventory request/service/session has not yet succeeded, the A-IoT device may wait and/or participate in the next inventory/random access round in the corresponding inventory request/service/session to receive an initial trigger message indicating the start of the next inventory/random access round for the corresponding inventory request/service/session.

5) T4: T4 may refer to a time/minimum time/maximum time interval from when the A-IoT device receives Msg 2 510 including a random sequence/temporal ID/permanent ID/all or part of A-IoT device information, such as the random sequence/temporal ID/permanent ID/A-IoT device information transmitted in Msg 1 509, to when the A-IoT device transmits Msg 3 511. According to an embodiment, the initial trigger message 506 may indicate the size and/or minimum size and/or maximum size of T4. According to an embodiment, the size and/or minimum size and/or maximum size of T4 may be defined as a specific value in advance (or in the specifications). According to an embodiment, the A-IoT device having received Msg 2 may transmit Msg 3 within the time/minimum time/maximum time of T4.

6) T5: T5 may refer to a time/minimum time/maximum time interval from when the A-IoT device transmits Msg 3 511, 517 and 522 to when the A-IoT device receives Msg 4 512, 518 and 523 including all or some of bits transmitted in Msg 3. According to an embodiment, the initial trigger message 506 may indicate the size and/or the minimum size and/or the maximum size of T5. According to an embodiment, the size and/or the minimum size and/or the maximum size of T5 may be defined as a specific value in advance (or in the specifications). According to an embodiment, when the A-IoT device does not receive Msg 4 in T5 or the minimum time of T5 or the maximum time of T5, the inventory/random access may be considered to have failed, the inventory/random access in the corresponding inventory/random access round for the corresponding inventory request/service/session may be considered to have failed, or the corresponding inventory request/service/session may be considered to have not yet succeeded. According to an embodiment, when the inventory/random access has failed, the inventory/random access in the corresponding inventory/random access round for the corresponding inventory request/service/session has failed, or the inventory request/service/session has not yet succeeded, the A-IoT device may wait and/or participate in the next inventory/random access round in the corresponding inventory request/service/session to receive an initial trigger message indicating the start of the next inventory/random access round for the corresponding inventory request/service/session.

The initial trigger message 506 may include an indicator indicating a random access type to be performed in this inventory/random access round. According to an embodiment, the random access type indicator may indicate one of two-step or four-step random access and/or one of contention-based or contention-free random access. According to an embodiment, when the two-step random access is indicated, the A-IoT device may include the A-IoT device information in Msg 1. According to an embodiment, the A-IoT device information included in Msg 1 may include the permanent ID of the A-IoT device assigned in advance or the ID of the item/object to which the A-IoT device is attached and/or information about the A-IoT device. According to an embodiment, the A-IoT device information included in Msg 1 may include the feature/function (capability) of the A-IoT device or the item/thing to which the A-IoT device is attached. According to an embodiment, when the random access type indicator indicates the four-step random access, the A-IoT device may include the random sequence/temporal ID (which may have a length of, for example, 16 bits or more) randomly generated by the A-IoT device in Msg 1.

According to various embodiments of the disclosure, after receiving the initial trigger message 506, the A-IoT device may determine whether the A-IoT device satisfies the target A-IoT device criteria of the initial trigger message 506. According to an embodiment, the foregoing determination may be performed in a higher layer rather than a radio access network (RAN) layer.

According to an embodiment, when the target A-IoT device criteria is satisfied and/or the inventory has failed/has not yet succeeded with respect to the inventory request/service/session, the A-IoT device may randomly select one random access occasion, based on the random access occasion-related configuration information of the initial trigger message 506, to transmit Msg 1. According to an embodiment, when the random access occasion-related configuration information includes the time domain configuration information, the A-IoT device may randomly select one time slot/random access occasion (in a time domain) among all time slots/random access occasions to transmit Msg 1. According to an embodiment, when the value of Q is configured in the time domain configuration information, the A-IoT device may select one of [0, 2^{Q}-1] or [1, 2^{Q}] time slots/random access occasions (in the time domain) to transmit Msg 1 509, 515, and 520. According to an embodiment, when the total number of time slots/random access occasions (time domain) is configured to K in the time domain configuration information, the A-IoT device may select one of [0, K-1] or [1, K] time slots/random access occasions (time domain) to transmit Msg 1 509, 515, and 520. According to an embodiment, when the random access occasion-related configuration information includes the frequency domain configuration information, the A-IoT device may select one of frequency shift/line coding parameters configured by the A-IoT reader through the initial trigger message and apply a corresponding line coding/frequency shift to transmit Msg 1 509, 515, and 520. According to an embodiment, when the random access occasion-related configuration information includes the code domain configuration information, the A-IoT device may randomly select one of code sequences indicated by the A-IoT reader in the initial trigger message, may transmit Msg 1 509, 515, and 520 including the code sequence.

According to an embodiment, when the target A-IoT device criteria is not satisfied and/or the inventory has already succeeded with respect to the inventory request/service/session, the A-IoT device may not participate in the inventory/random access process. For example, the A-IoT device may not transmit Msg 1 509, 515, and 520.

According to various embodiments of the disclosure, the A-IoT device may autonomously determine a randomly selected time slot/random access occasion to transmit Msg 1 509, 515, and 520, based on a random access occasion-related configuration. According to an embodiment, the start time of the first time slot/random access occasion is the same as the end of the initial trigger message 506, or the A-IoT device may determine the time slot/random access occasion by applying a specific time offset. According to an embodiment, the time offset may be configured in the initial trigger message 506, or may be defined in advance (or in the specifications).

According to various embodiments of the disclosure, when the A-IoT device receives a specific message (which may be referred to as, for example the slot start message 507, 508, 513, 514 and 519 but is not limited in designation in the disclosure) indicating the start of the time slot/random access occasion (in the time domain) transmitted by the A-IoT reader, the A-IoT device may consider the end/start time of the message (or the end/start time of the message plus a specific time offset) as the start or start time of a new time slot/random access occasion. According to an embodiment, the time offset may be predefined in advance (or in the specifications) or configured through the initial trigger message 506. According to an embodiment, when the value of Q is configured in the initial trigger message 506, the A-IoT device receiving the message may configure a random value of [0, 2^{Q}−1] or [1, 2^{Q}] as a counter value related to the time slot/random access occasion. According to an embodiment, when the total number of time slots/random access occasions is configured to K in the initial trigger message 506, the A-IoT device receiving the message may configure a random value of [0, K-1] or [1, K] as the counter value related to the time slot/random access occasion. According to an embodiment, when the A-IoT device receives a slot start message, the A-IoT device may decrease the counter value related to the time slot/random access occasion by 1. According to an embodiment, when the counter value related to the time slot/random access occasion is 0, the A-IoT device may transmit Msg 1 509, 515, and 520 in the corresponding time slot/random access occasion. According to an embodiment, when a counter value related to the randomly selected time slot/random access occasion is initially 0 (e.g., when the first time slot/random access occasion is selected), the A-IoT device may transmit Msg 1 509, 515, and 520 immediately after receiving the initial trigger message 506 (or after adding the specific time offset). According to an embodiment, the time interval between Msg 1 transmitted by the A-IoT device selecting the first time slot/random access occasion and the immediately preceding initial trigger message or slot start message may be greater than the minimum of T2 and/or less than the maximum of T2. According to an embodiment, the time interval between Msg 1 transmitted by the A-IoT device selecting a time slot/random access occasion other than the first time slot/random access occasion and the immediately preceding slot start message may be greater than the minimum of T2 and/or less than the maximum of T2.

According to various embodiments of the disclosure, Msg 1 may include at least one of the following information.

Msg 1 may include the random sequence/temporal ID (which may have a length of, for example, 16 bits or more) randomly generated by the A-IoT device. The length of the random sequence or temporal ID is in bits or bytes, and may be configured by the A-IoT reader through the initial trigger message 506 or defined in advance (or in the specifications).

Msg 1 may include the permanent ID of the A-IoT device assigned in advance to the A-IoT device or the ID of the item/object to which the A-IoT device is attached. For example, Msg 1 may include the information about the A-IoT device. The information about the A-IoT device may include the feature/function (capability) of the A-IoT device or the item/object to which the A-IoT device is attached.

Msg 1 may include one code sequence randomly selected by the A-IoT device among the code sequences configured by the A-IoT reader when the random access occasion-related configuration information in the initial trigger message 506 includes the code domain configuration information.

According to an embodiment, when the frequency domain configuration information is included in the random access occasion-related configuration information in the initial trigger message 506 (or is configured in advance (or in the specifications)), the A-IoT device may randomly select one of frequency shifts (frequency channels) supportable by the A-IoT device and/or allowed through the initial trigger message, and may transmit Msg1 509, 515, and 520 by applying the line coding/frequency shift.

According to an embodiment, when a plurality of A-IoT devices transmits messages 1 (Msg 1) 509, 515, and 520 by applying different frequency shifts (frequency channels)/line coding in the same time slot/random access occasion, the A-IoT reader may distinguish and receive messages 1 (Msg 1), based on the different frequency shifts (frequency channels).

According to an embodiment, when a plurality of A-IoT devices transmits messages 1 (Msg 1) 509, 515, and 520 by applying the same frequency shift (frequency channel)/line coding in the same time slot/random access occasion and Msg 1 includes different code sequences, the A-IoT reader may distinguish and receive messages 1 (Msg 1), based on the different code sequences.

According to various embodiments of the disclosure, the A-IoT reader having successfully received one or more messages 1 (Msg 1) in a particular time slot/random access occasion may transmit Msg 2 after receiving Msg 1.

According to an embodiment, the interval between Msg 1 and Msg 2 may be greater than the minimum of T3 and/or less than the maximum of T3.

According to an embodiment, Msg 2 may include at least one of the following information.

Msg 2 may include at least one of the random sequence, the temporal ID, the permanent ID, the code sequence (index), or the information about A-IoT device included in Msg 1 successfully received in the time slot/random access occasion. According to an embodiment, Msg 2 may include all or part of the payload of Msg 1. According to an embodiment, the length of the payload of Msg 1 included in Msg 2 may be configured through the initial trigger message 506. This message may be used to indicate successful reception of Msg 1 to the A-IoT device having transmitted Msg 1 and/or to trigger transmission of Msg 3 and/or to indicate success of the inventory (with respect to the inventory request/service/session). According to an embodiment, Msg 2 may include at least one of a plurality of random sequences, temporal IDs, permanent IDs, code sequences (indexes), or all or some payloads of Msg 1 corresponding to a plurality of messages 1 (Msg 1) received through the different frequency shifts and/or code sequences.

Msg 2 may include information indicating the presence or absence of Msg 4and/or the length of Msg 4.

Msg 2 may indicate a line coding/frequency shift parameter corresponding to a frequency shift (frequency channel) to be applied when transmitting Msg 3. According to an embodiment, when Msg 3 is triggered for a plurality of A-IoT devices, a line coding/frequency shift parameter corresponding to a frequency shift (frequency channel) may also be indicated for each of the plurality of A-IoT devices.

According to an embodiment, the A-IoT device receiving Msg 2 may determine whether at least one of the random sequence, the temporal ID, the permanent ID, the code sequence, or all or part of the payload included in Msg 1 transmitted by the A-IoT device is included in Msg 2.

1) When included: According to an embodiment, the A-IoT device may consider the random access and/or inventory (with respect to the inventory request/service/session) as successful. According to an embodiment, the A-IoT device may transmit Msg 3 to the A-IoT reader. According to an embodiment, when Msg 2 includes configuration information about a frequency shift (frequency channel)/line coding corresponding to the A-IoT device, the A-IoT device may transmit Msg 3 by applying the line coding/frequency shift, based on the configuration information. According to an embodiment, when Msg 2 does not include configuration information about the frequency shift (frequency channel)/line coding corresponding to the A-IoT device, the A-IoT device may transmit Msg 3 by applying at least one of a specific (e.g., default) line coding/frequency shift defined in the specifications, the line coding/frequency shift applied when transmitting Msg 1, or a line coding/frequency shift determined by the configuration of the A-IoT device without a frequency shift. According to an embodiment, the time interval between Msg 2 and Msg 3 may be greater than the minimum of T4 and/or less than the maximum of T4.

2) When not included: The A-IoT device may consider that the inventory/random access has failed in the inventory/random access round (with respect to the Inventory request/service/session) or that the inventory/random access has not yet succeeded with respect to the inventory request/service/session.

According to an embodiment, when not receiving Msg 2 within the time/minimum time/maximum time of T3 and/or receiving other messages (e.g., the slot start message, the initial trigger message, and Msg 4) transmitted by the A-IoT reader before receiving Msg 2, the A-IoT device transmitting Msg 1 may consider that the inventory/random access has failed, that the inventory/random access has not yet succeeded with respect to the inventory request/service/session, or that the inventory/random access in this inventory/random access round has failed.

According to various embodiments of the disclosure, Msg 3 may include at least one of the following information.

Msg 3 may include the information about the A-IoT device transmitting Msg 3. According to an embodiment, the information about the A-IoT device may include at least one of the capability of the A-IoT device, the permanent ID of the A-IoT device, or the ID, characteristic, or function of the item/thing to which the A-IoT device is attached. According to an embodiment, information to be included in the information about the A-IoT device may be determined in a higher layer rather than the RAN layer. According to an embodiment, the information to be included in the information about the A-IoT device may be configured through the initial trigger message 506.

According to various embodiments of the disclosure, when Msg 4 is configured to exist and/or to have a length greater than 0 through the initial trigger message or Msg 2, when there is no configuration related to Msg 4 in the initial trigger message or Msg 2, or when Msg 4 always exists, the A-IoT device may receive Msg 4 after transmitting Msg 3. According to an embodiment, the time interval between Msg 3 and Msg 4 may be greater than the minimum of T5 and/or less than the maximum of T5.

According to an embodiment, Msg 4 may include at least one of the following information.

Msg 4 may include all or part of the payload included in Msg 3 transmitted by the receiving A-IoT device. According to an embodiment, Msg 4 may include all or some of the random sequence/temporal ID/permanent ID transmitted by the A-IoT device via Msg 1. According to an embodiment, the part of the payload may include a specific length of the payload from the first bit. According to an embodiment, the length of the part of the payload may be defined in advance (or in the specifications), configured via the initial trigger message, or configured via Msg 2. According to an embodiment, when there is a plurality of A-IoT devices receiving Msg 4, Msg 4 may include all or part of the payload of each of Msg 3 or Msg 1 transmitted by the A-IoT devices. According to an embodiment, Msg 4 may additionally include at least one of the random sequence, temporal ID, or permanent ID of Msg 1 transmitted by the A-IoT device before all or part of the payload of Msg 3 to indicate all or part of Msg 3 corresponding to each target A-IoT device or for the purpose of ordering.

According to an embodiment, the A-IoT device receiving Msg 4 may determine whether the payload of Msg 3 or Msg 1 transmitted by the A-IoT device is included entirely or as long as the configured length. When the payload is included, the A-IoT device may consider that the inventory/random access has succeeded with respect to the inventory request/service/session. When the payload is not included, the A-IoT device may consider that the inventory/random access has failed, that the inventory/random access has not yet succeeded with respect to the inventory request/service/session, or that the inventory/random access has failed in this inventory/random access round.

According to an embodiment, when not receiving Msg 4 within the time/minimum time/maximum time of T5 and/or receiving other messages (e.g., at least one of the slot start message, the initial trigger message, and an NACK message (e.g., when Msg 3 or the information included in Msg 3 is invalid)) transmitted by the A-IoT reader before receiving Msg 4, the A-IoT device transmitting Msg 3 may consider that the inventory/random access has failed, that the inventory/random access has not yet succeeded with respect to the inventory request/service/session, or that the inventory/random access in this inventory/random access round has failed.

According to an embodiment, when receiving Msg 2 including at least one of the random sequence, the temporal ID, the permanent ID, the code sequence, or all or part of the payload included in Msg 1 transmitted by the A-IoT device, the A-IoT device transmitting Msg 3 may (re)transmit Msg 3.

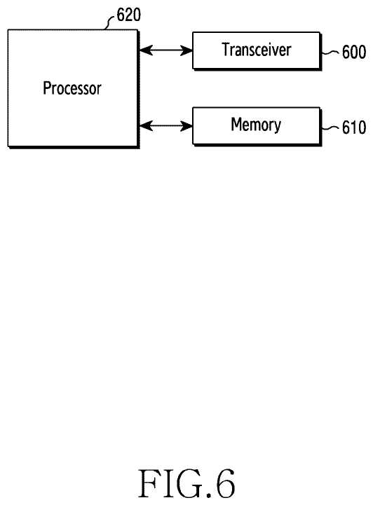

FIG. 6 illustrates an example configuration of a user equipment (UE) according to various embodiments of the disclosure. According to an embodiment, the UE of FIG. 6 is a designation for convenience, and may include at least one of a user terminal, a terminal, an electronic device, an A-IoT reader, or an A-IoT device.

The UE according to an embodiment of the disclosure may include a processor (or controller) 620 to control the overall operation of the UE, a transceiver 600 including a transmitter and a receiver, and a memory 610. The UE is not limited to the foregoing example, and may include more or fewer components than those illustrated in FIG. 6.

According to an embodiment of the disclosure, the transceiver 600 may transmit and receive a signal to and from a base station or other devices. The signal transmitted and received by the UE may include control information and data. Further, the transceiver 600 may receive a signal through a radio channel to output the signal to the processor 620, and may transmit a signal output from the processor 620 through the radio channel.

According to an embodiment of the disclosure, the processor 620 may control the UE to perform an operation according to one of the foregoing embodiments. The processor 620, the memory 610, and the transceiver 600 are not necessarily configured as separate modules, but may be configured as a single component in the form of a single chip. The processor 620 and the transceiver 600 may be electrically connected. The processor 620 may include an application processor (AP), a communication processor (CP), a circuit, an application-specific circuit, a controller, or at least one processor.

According to an embodiment of the disclosure, the memory 610 may store data, such as a basic program, an application program, and configuration information, for the operation of the UE. In particular, the memory 610 may provide the stored data upon request from the processor 620. The memory 610 may be configured as a storage medium, such as ROM, RAM, a hard disk, CD-ROM, and a DVD, or a combination of storage media. The memory 610 may include a plurality of memories. The processor 620 may perform the foregoing embodiments, based on a program for performing the foregoing embodiments of the disclosure stored in the memory 610.

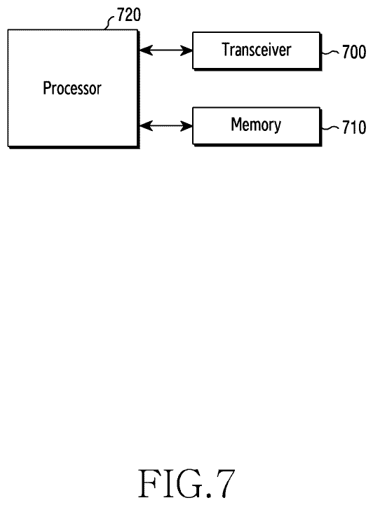

FIG. 7 illustrates an example configuration of a base station according to various embodiments of the disclosure. According to an embodiment, the base station of FIG. 7 is a designation for convenience, and may include at least one of a base station or an A-IoT reader.

The base station according to an embodiment of the disclosure may include a processor (or controller) 720 to control the overall operation of the base station, a transceiver 700 including a transmitter and a receiver, and a memory 710. The base station is not limited to the foregoing example, and may include more or fewer components than those illustrated in FIG. 7.

According to an embodiment of the disclosure, the transceiver 700 may transmit and receive a signal to and from at least one of network entities or other devices. The signal transmitted and received by the base station may include control information and data.

According to an embodiment of the disclosure, the processor 720 may control the base station to perform an operation according to one of the foregoing embodiments. The processor 720, the memory 710, and the transceiver 700 are not necessarily configured as separate modules, but may be configured as a single component in the form of a single chip. The processor 720 and the transceiver 700 may be electrically connected. The processor 720 may include an application processor (AP), a communication processor (CP), a circuit, an application-specific circuit, a controller, or at least one processor.

According to an embodiment of the disclosure, the memory 710 may store data, such as a basic program, an application program, and configuration information, for the operation of the base station. In particular, the memory 710 may provide the stored data upon request from the processor 720. The memory 710 may be configured as a storage medium, such as ROM, RAM, a hard disk, CD-ROM, and a DVD, or a combination of storage media. The memory 710 may include a plurality of memories. The processor 720 may perform the foregoing embodiments, based on a program for performing the foregoing embodiments of the disclosure stored in the memory 710.

It should be noted that the above-described configuration diagrams, illustrative diagrams of control/data signal transmission methods, illustrative diagrams of operation procedures, and structural diagrams are not intended to limit the scope of the disclosure. That is, all constituent elements, entities, or operation steps described in the embodiments of the disclosure should not be construed as being essential for the implementation of the disclosure, and the disclosure may be implemented without impairing the essential features of the disclosure by including only some constituent elements. Also, the above respective embodiments may be employed in combination, as necessary. For example, the methods proposed in the disclosure may be partially combined with each other to operate a network entity and a terminal.

The above-described operations of a base station or terminal may be implemented by providing any unit of the base station or terminal device with a memory device storing corresponding program codes. That is, a controller of the base station or terminal device may perform the above-described operations by reading and executing the program codes stored in the memory device by means of a processor or central processing unit (CPU).

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof. That is, it will be apparent to those skilled in the art that other variants based on the technical idea of the disclosure may be implemented. Also, the above respective embodiments may be employed in combination, as necessary. As an example, the methods proposed in the disclosure may be partially combined with each other to operate a base station and a terminal. Moreover, although the above embodiments have been described based on the 5G or NR system, other variants based on the technical idea of the embodiments may also be implemented in other communication systems such as LTE, LTE-A, or LTE-A-Pro systems.

Although the present disclosure has been described with various embodiments, various changes and modifications may be suggested to one skilled in the art. It is intended that the present disclosure encompass such changes and modifications as fall within the scope of the appended claims.

What is claimed is:

1. An ambient-internet of things (A-IoT) device in a wireless communication system, the A-IoT device comprising:
a transceiver; and
a controller coupled to the transceiver, the controller configured to:
receive, from an A-IoT reader, an A-IoT paging message including at least one access occasion for a random access,
determine an access occasion among the at least one occasion,
generate a 16-bit random identifier (ID), and
transmit, to the A-IoT reader, a message 1 including the 16-bit random ID on the access occasion.

2. The A-IoT device of claim 1,
wherein the controller is further configured to receive, from the A-IoT reader, a message 2 as a response to the message 1, and
wherein the message 2 includes the 16-bit random ID for indicating a successful random access.

3. The A-IoT device of claim 1,
wherein the A-IoT paging message includes an indicator indicating a random access type for the A-IoT device, and
wherein the random access type includes a contention-based random access or a contention-free random access.

4. The A-IoT device of claim 1,
wherein the A-IoT paging message includes an ID for the A-IoT device or a group ID for one or more A-IoT devices, or
wherein the A-IoT paging message does not include any ID for A-IoT devices.

5. An ambient-internet of things (A-IoT) reader in a wireless communication system, the A-IoT reader comprising:
a transceiver; and
a controller coupled to the transceiver, the controller configured to:
transmit an A-IoT paging message including at least one access occasion for a random access, and
receive, from an A-IoT device, a message 1 including a 16-bit random identifier (ID) on an access occasion among the at least one occasion.

6. The A-IoT reader of claim 5,
wherein the controller is further configured to transmit, to the A-IoT device, a message 2 as a response to the message 1, and
wherein the message 2 includes the 16-bit random ID for indicating a successful random access.

7. The A-IoT reader of claim 5,
wherein the A-IoT paging message includes an indicator indicating a random access type for the A-IoT device, and
wherein the random access type includes a contention-based random access or a contention-free random access.

8. The A-IoT reader of claim 5,
wherein the A-IoT paging message includes an ID for the A-IoT device or a group ID for one or more A-IoT devices, or
wherein the A-IoT paging message does not include any ID for A-IoT devices.

9. A method performed by an ambient-internet of things (A-IoT) device in a wireless communication system, the method comprising:
receiving, from an A-IoT reader, an A-IoT paging message including at least one access occasion for a random access;
determining an access occasion among the at least one occasion;
generating a 16-bit random identifier (ID); and
transmitting, to the A-IoT reader, a message 1 including the 16-bit random ID on the access occasion.

10. The method of claim 9, further comprising:
receiving, from the A-IoT reader, a message 2 as a response to the message 1,
wherein the message 2 includes the 16-bit random ID for indicating a successful random access.

11. The method of claim 9,
wherein the A-IoT paging message includes an indicator indicating a random access type for the A-IoT device, and
wherein the random access type includes a contention-based random access or a contention-free random access.

12. The method of claim 9,
wherein the A-IoT paging message includes an ID for the A-IoT device or a group ID for one or more A-IoT devices, or
wherein the A-IoT paging message does not include any ID for A-IoT devices.

13. A method performed by an ambient-internet of things (A-IoT) reader in a wireless communication system, the method comprising:
transmitting an A-IoT paging message including at least one access occasion for a random access; and
receiving, from an A-IoT device, a message 1 including a 16-bit random identifier (ID) on an access occasion among the at least one occasion.

14. The method of claim 13, further comprising:
transmitting, to the A-IoT device, a message 2 as a response to the message 1, wherein the message 2 includes the 16-bit random ID for indicating a successful random access.

15. The method of claim 13,
wherein the A-IoT paging message includes an indicator indicating a random access type for the A-IoT device, and
wherein the random access type includes a contention-based random access or a contention-free random access.

16. The method of claim 13,
wherein the A-IoT paging message includes an ID for the A-IoT device or a group ID for one or more A-IoT devices, or wherein the A-IoT paging message does not include any ID for A-IoT devices.
